(19) United States
(12) Patent Application Publication
(10) Pub. No.: US 2020/0382367 A1
(43) Pub. Date: Dec. 3, 2020

(54) SYSTEMS AND METHODS FOR CONFIGURING A DEVICE ACTION BASED ON ONE OR MORE EVENTS

(71) Applicant: PM POWER PRODUCTS LLC, Dublin, OH (US)

(72) Inventors: ROBERT RANKIN, DUBLIN, OH (US); MATTHEW BAUER, DUBLIN, OH (US)

(73) Assignee: PM POWER PRODUCTS LLC, Dublin, OH (US)

(21) Appl. No.: 16/796,483

(22) Filed: Feb. 20, 2020

Related U.S. Application Data
(60) Provisional application No. 62/783,836, filed on Dec. 21, 2018.

(51) Int. Cl. H04L 12/24; H04L 29/08; G06F 3/0482; G06F 3/0481

(52) U.S. Cl. CPC H04L 41/0803; H04L 41/0879; G06F 3/04817; H04L 41/22; G06F 3/0482; H04L 67/12

(57) ABSTRACT

Disclosed are a system and method comprising: providing a user interface to a user positioned remote from the server; receiving, from the user via the user interface: configuration data to configure a plurality of devices positioned remote from, and in communication with, the server; and rule data including user-defined rules governing one or more processing actions for execution by the server upon receipt by the server of one or more input signals from a first device; storing the configuration and rule data in a memory in association with the server; wherein in response to the server receiving the one or more input signals from the first device, the server determines one or more output signals according to the rule data and the configuration data; and wherein the server causes the one or more output signals to be transmitted to at least one second device to cause an event to occur.

### CROSS-REFERENCE TO RELATED APPLICATIONS

This patent application claims the benefit of U.S. Provisional Patent Application No. 62/783,836, filed on Dec. 21, 2018, which is hereby incorporated by reference in its entirety.

### TECHNICAL FIELD

The present application relates to the field of connected devices and, more specifically, to systems and methods for configuring a device action based on one or more events.

### BACKGROUND

Current IoT (Internet of Things) devices (e.g., sensors, relays, digital inputs/outputs, IoT connected hardwired buttons, or IoT connected wireless buttons) have a set of predefined actions that the IoT devices can perform. These actions, once defined by the manufacturer or a third party, typically cannot be modified by an end user, e.g., a consumer. In some cases, IoT devices have a single use and a single purpose.

An issue with single purpose devices is just that: they are single purpose. They exist to perform a single purpose and cannot deviate from that single purpose.

An unsolved need exists to have a combination of hardware and software that can add increased flexibility to IoT devices.

### SUMMARY

Some aspects of the disclosure provide a method, device, and computer-readable storage medium for operating an Internet of things (IoT) ecosystem composed of devices having disparate sources or functions and that are capable of input/output (I/O) of signals to or from a server associated with the IoT ecosystem. The method comprises: providing a user interface to a user positioned remote from the server; receiving, from the user via the user interface: configuration data to configure a plurality of devices positioned remote from, and in communication with, the server; and rule data including user-defined rules governing one or more processing actions for execution by the server upon receipt by the server of one or more input signals from a first device of the plurality of devices; storing the configuration data and the rule data in a memory device in association with the server; wherein in response to the server receiving the one or more input signals from the first device, the server determines one or more output signals according to the rule data and the configuration data; and wherein the server causes the one or more output signals to be transmitted to at least one second device of the plurality of devices to cause an event to occur at the second device.

In another aspect of the disclosure, providing the user interface to the user comprises providing a graphical user interface (GUI) on a display device to receive modifications of the configuration data and the rules data by the user; and receiving the configuration data and the rules data from the user comprises receiving the configuration data and the rules data via the GUI.

In another aspect of the disclosure, the GUI further includes a graphical button; and the first device comprises a user device operated by the user; and receiving the one or more input signals from the first device comprises receiving an input signal from the user device corresponding to the graphical button being activated by the user.

In another aspect of the disclosure, the first device includes a personal alerting device (PAD); receiving the one or more input signals from the first device comprises receiving the one or more input signals from a hub device positioned in communication with the PAD and the server; wherein the hub device is located in a same location as the PAD device; and wherein the hub device is located in a different location as the server.

In another aspect of the disclosure, the at least one second device includes at least one user device associated with the user; the rules data includes at least one predetermined message; and transmitting the one or more output signals to the at least one second device comprises transmitting the at least one predetermined message to the at least one user device.

In another aspect of the disclosure, the configuration data includes one or more of: at least one telephone number associated with the user; at least one email address associated with the user; or at least one social media account associated with the user; and the rules data includes at least one predetermined message; and transmitting the one or more output signals to the at least one second device comprises transmitting the at least one predetermined message to the one or more of: the at least one telephone number, the at least one email address, or the at least one social media account.

In another aspect of the disclosure, receiving one or more signals from the first device or the at least one second device, wherein the one or more signals are representative of an operational status of the first device or the at least one second device; and determining the operational status of the first device or the at least one second device based on the one or more signals representative of the operational status of the first device or the at least one second device.

In another aspect of the disclosure, determining one or more control signals according to the operational status of the first device or the at least one second device; and transmitting the one or more control signals to the first device or the at least one second device to maintain or change to the operational status of the first device or the at least one second device.

In another aspect of the disclosure, the at least one second device further includes at least one user device associated with the user; the rules data includes at least one device operational status message; and transmitting the one or more control signals to the first device or the at least one second device comprises transmitting the at least one device operational status message to the at least one user device.

In another aspect of the disclosure, the first device includes at least one of: a sensor, an actuator, or a communication device; the at least one second device includes, or is operably coupled to, one or more components of a facility control system associated with the identity of the user; and transmitting the one or more output signals to the at least one second device further facilitates control of physical infrastructure of the facility according to the one or more input signals received from the first device.

In another aspect of the disclosure, the at least one second device further includes at least one user device associated with the identity of the user; the rules data includes at least one facility control status message; and transmitting the one or more output signals to the at least one second device comprises transmitting the at least one facility control status message to the at least one user device.

In another aspect of the disclosure, the server causes the one or more output signals to be transmitted to at least two second devices of the plurality of devices to cause the event to occur at the at least two second devices.

### BRIEF DESCRIPTION OF THE DRAWINGS

FIG. 1 is a block diagram of a system in accordance with certain embodiments of the disclosure.

FIG. 2 is a block diagram of basic functional components for a computing device according to some aspects of the disclosure.

FIG. 3 is a block diagram illustrating an example use case of the disclosed system, according to one embodiment.

FIG. 4 is a flow diagram of method steps for generating a rule to cause one or more actions in response to detecting one or more events, according to one embodiment.

FIG. 5 is a flow diagram of method steps for executing a rule to cause one or more actions in response to detecting one or more events, according to one embodiment.

FIGS. 6-8 illustrate example GUIs (graphical user interfaces) for creating a new Calling Group, according to one embodiment.

FIG. 9 illustrates a GUI to create a new contact, according to one embodiment.

FIG. 10 illustrates a GUI to add an existing contact to a new calling group, according to one embodiment.

FIG. 11 illustrates a GUI to create a new recording to be used for notifications, according to one embodiment.

FIG. 12 illustrates a GUI to add a new PAD (personal alert device) to the system, according to one embodiment.

FIG. 13 illustrates a GUI to add a new rule to the system, according to one embodiment.

FIGS. 14A-14C illustrate a GUI to add conditions to a rule, according to one embodiment.

FIG. 15 illustrates a GUI to add actions to a rule, according to one embodiment.

FIGS. 16A-16B illustrate a GUI to add an action to send an email to one or more individuals, according to one embodiment.

FIG. 17 illustrates a GUI to add an action to send a text message to an individual, according to one embodiment.

FIG. 18 illustrates a GUI to add an action to send a text message to a group, according to one embodiment.

FIG. 19 illustrates a GUI to add an action to make a phone call to an individual where the text is read to the called party, according to one embodiment.

FIG. 20 illustrates a GUI to add an action to make a phone call to an individual where a recording is played to the called party, according to one embodiment.

FIG. 21 illustrates a GUI to add an action to make a phone call to a group where the text is read to the called party/parties, according to one embodiment.

FIG. 22 illustrates a GUI to add an action to make a phone call to a group where a recording is played to the called party/parties, according to one embodiment.

FIG. 23 illustrates a GUI to add an action to trigger a relay, according to one embodiment.

### DETAILED DESCRIPTION

Embodiments of the disclosure provide for IoT devices that can change state creating an event that can be detected. When an event is detected, the disclosed hardware and/or software is programmed to perform one or more actions based upon consumer driven requirements. In some cases, the consumer driven requirements may be outside the initial purpose of the device. Example IoT devices include sensors, hardwired buttons, wireless IoT buttons, or any other type of device.

In one embodiment, when an event is detected at a consumer site, the disclosed system can receive a request (or a series of requests) based on parameters within or outside of that event. Events can be single function or multi-function. Events can be detected at devices that are hardwired, wireless, cellular buttons, sensors, IoT devices, or any other device or software application that is connected and is capable of changing state. These devices can be wired, wireless, cellular, or applications connected via a third party API (application programming interface) providing a wide variety of functionality for the customer and the environment they are placed in.

Utilizing the disclosed embodiments, consumers are provided the ability to define which actions are performed when an event is detected at a connected IoT device, a wired or wireless IoT button is pressed, a sensor detects an event, an event occurs that activates hardware connected to the disclosed software, or an event occurs in a software application that is then sent to the disclosed software, among other example implementations. The disclosed system allows for a single action or multiple actions to be defined and determined by any of the aforementioned events or information sent by these events. These actions may also be dependent upon the conditional state of one or more other connected devices or applications to the disclosed system, e.g., via relays or digital inputs/outputs, the user of the software, a location of the event, an environment through a variety of available sensors or devices connected to the disclosed hardware, custom variables within the disclosed software, or requests sent to or received by the disclosed software from other software applications, among other things.

Example actions that can be programmed to occur upon the detection of one or more events include, but are not limited to, sending one or more emails, making one or more phone calls, sending one or more SMS (short message service) message, or SNS (simple notification service) messages, among others. The messages and/or call can be directed to a single person/user or groups of people/users, as defined by the consumer.

In various embodiments, combinatorial logic can be used to generate rules for one or more actions to take place in response to one or more events. Example logic includes IF, ELSE IF, ELSE, While, Loops, and Switch statements as configured by the consumer to provide additional flexibility. In various embodiments, actions can occur immediately, in series, in parallel, on a delay, or scheduled based upon specified user requirements.

In various embodiments, due to the system architecture, the devices (e.g., buttons, sensors, relays, digital inputs/outputs, and other devices connected in the disclosed system) can be geographically disbursed. In some implementations, one event detected at Location A can trigger one or more actions on one or more devices at Locations B, C, or D. The one or more actions on the one or more devices at Locations B, C, or D can then trigger additional events (at the same location(s) or other location(s)).

In some implementations, web-based “soft” buttons can trigger an event to occur within the system. These soft buttons can be programmed to, but are not limited to, sending notification of an event, triggering additional events by a state change, sending information to third party systems to then trigger additional events via an API, etc.

One embodiment utilizes a “call-in feature,” where a consumers/user can call a dedicated phone number, or alternatively, use a text/SMS. The phone and/or text system can verify the user via PIN (personal identification number) and/or caller ID (identification) verification. Once verified, the user is presented with a menu of options to cause one or more events to occur. Some options for events include: recording and sending a message, activating a relay, activating a programmed web based soft button, sending information to a third party system to trigger additional events via an API, etc.

Some embodiments involve a wireless connected IoT button. Example IoT buttons include an AWS (Amazon Web Services) Developer Button, AWS 1-Click Button, AWS IoT Button, AWS AT&T LTE-M Button, a “Thingstream” IoT button, and a “bttn” button (i.e., available at https://bt.tn), or a specially designed custom button for use in a particular device, among others. Various embodiments can utilize these single-function or multi-function buttons to perform actions based upon a button press event received. Through these provided button press events, embodiments of the disclosure can detect the event and then act based upon the consumer requirements to cause one or more actions to occur. The one or more actions can include, but is not limited to, triggering a relay on one or multiple devices, sending emails, phone calls, SMS or SNS messages to a single person or groups of people, sending additional events to third party software via an API, activating pre-programmed web based soft buttons in the disclosed software, etc.

In some embodiments, the functionality of these single-function or multi-function buttons is extended through conditional statements. For example, a single press event a first time may trigger one action, but a second single press event from the same button may trigger a different action. By taking these different button press events into account, some embodiments can extend the button press events of the buttons to 6, 12, 18, 24 or more different actions using a single device.

Some embodiments involve a scheduling component. Through the scheduling component, actions can be defined to take place when an event is received during a specific time period, if the number of and type of events received during a time period is above a specific threshold, or based on the information included within that event. Actions can also be automatically executed at a specific time, utilizing the programmed time as the event that triggers the actions as programmed by the consumer.

In some embodiments, information can be referenced from a detected event utilizing custom variables, allowing for that information to be used in notification events or events sent to third party applications via an API. For example, a customer may want to send the current temperature of a freezer to a group of users at a specific time. This action can easily be done using the disclosed scheduling component and sensor data assigned to a custom variable. The message that is sent can then include that variable within the text and the information will be sent to the notification group.

Through the various available options listed above, the disclosed embodiments put the consumer in control of what actions will take place when an event occurs that is detected by the disclosed hardware and software system or sent to the disclosed hardware or software by wired or wireless device or a third party API. Some embodiments leverage the distributed architecture of the disclosed hardware and software to detect events anywhere in the world with an internet connection. Events can be reported and acted upon based on consumer requirements and the actions the consumer programs. In one example, the consumer may be looking to monitor a pump and send a notification to a first group of users if a certain pump condition is detected. Also, when a button is pressed, the consumer may wish to cause one more different events to occur, such as to: (1) trigger a secondary backup pump to come online, (2) send a second alert to a second group of users when a button is pressed, (3) trigger one or multiple relays in locations around a city, and (4) send a notification to a map to designate the location where the button was pressed.

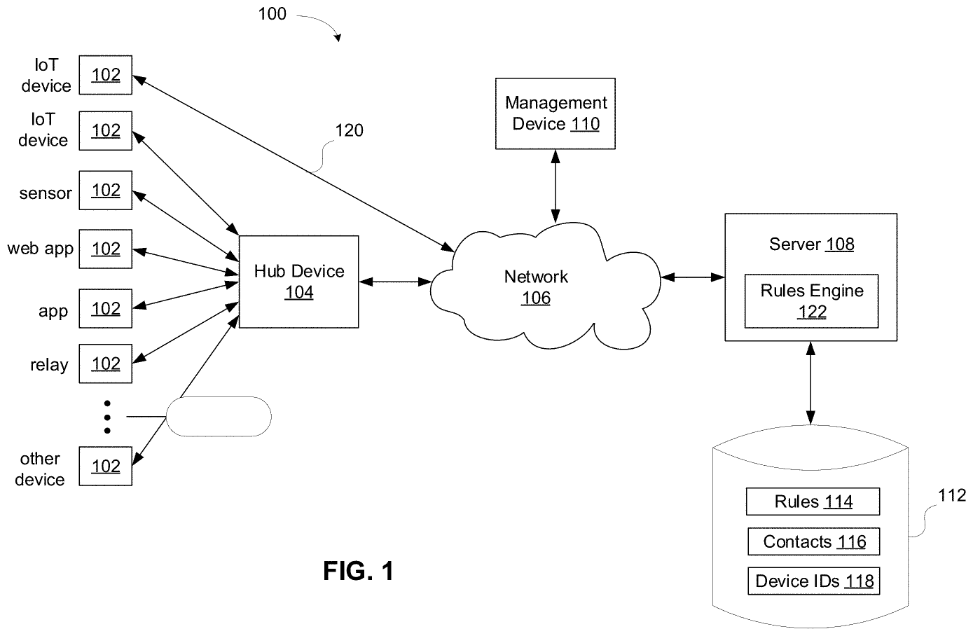

Turning now to the figures, FIG. 1 is a block diagram of a system 100 in accordance with certain embodiments of the disclosure. The system 100 includes devices 102, hub device 104, management computing device 110, server 108, and a database 112. The system 100 also includes one or more networks 106 connecting the various components of the system 100.

In various embodiments, the devices 102 can be many different types of devices, including but not limited to: an IoT device, an application on a client device, a web applications on a client device, a tracking device (e.g., GPS (global positioning system) monitor), a door, a door lock controller, a refrigerator, a refrigerator door, a refrigerator door lock controller, an air quality monitor sensor, a smoke detector/fire alarm, a moisture sensor, a manual button device with one or more buttons or switches, a relay/routing box, a workstation, a vehicle, a temperature control system (e.g., heater, air conditioner, or other HVAC device), a thermostat, a condenser, a power supply, a light bulb, a smart doorbell, a camera, a smart electrical socket, a smart vacuum, a smart appliance (e.g., washer or dryer), or any other type of device. Example client devices include smartphones, tablets, computers, or other electronic devices.

The management computing device 110 allows a user to customize one or more actions based on one or more events at one or more devices 102. The management computing device 110 can be any type of computing device that supports processing operations, including a server device, a personal computer, a laptop computer, a tablet, a telephone, a mobile phone, a smartphone, a smart watch, a personal digital assistant (PDA), a wearable or embedded digital device(s), etc. In some embodiments, the management computing device 110 can support multiple types of networks. For example, the management computing device 110 may have wired or wireless network connectivity using IP (Internet Protocol) or may have mobile network connectivity allowing over cellular and data networks and/or a satellite connection.

The management computing device 110 is configured to provide one or more graphical user interfaces in which a user can customize one or more rules for one or more actions to occur based on one or more events at one or more devices 102, as described in greater detail below.

In one embodiment, devices 102 may be communicatively coupled with a hub device 104. The hub device 104 is a computing device that includes communication hardware to allow device 102 to communicate with the hub device 104. In one embodiment, the hub device 104 is physically located at the same location as the device 102 that connect to the hub device 104. The hub device 104 is connected via network 106 to server 108. In some embodiments, a device 102 can connect to the network 106 without communicating with (i.e., bypassing) the hub device 104 (e.g., shown as connection 120).

In some embodiments, the hub device 104 can detect events that occur via a change in a logic state of a connected device 102. A device 102 is connected to the hub device 104 via a wired or wireless connection. The device 102 can communicate with the hub device 104 to provide information about changes in logic state(s) of the device 102. In one implementation, the hub device 104 may include SPDT (single pole double throw) relays that allow the hub device 104 to connected to the devices 102.

The device 102 may be a third party device 102 that is connected directly to the disclosed hub device 104 or connected via an API from the vendor of the third party device 102. This allows for additional flexibility by leveraging devices already at a user's location. This also allows for embodiments to leverage a wide range of IoT devices including but not limited to the range of available AWS IoT buttons with the disclosed hardware and software.

As described, a user can interact with the management computing device 110 to provide configuration information to set rules for actions to occur in response to detecting certain events at the device 102. The management computing device 110 communicates via network 106 with the server 108. The configured rules 114 and other configuration information, such as contact information 116 and device identifiers (IDs) 118, can be stored in a database 112. The database 112 is accessible by the server 108. The server 108 includes a rules engine 122 configured to execute the rules can instruct the one or more actions based on executing the rules 114.

During runtime, when an event is detected at one of the device 102, a signal is transmitted to rules engine 122 of the server 108. The server 108 may be a dedicated physical computing device or may be a distributed or virtualized server (e.g., provided via AWS, for example). As described, the signal may travel from the device 102 to the hub device 104, and then via network 106 from the hub device 104 to the server to be processed by the rules engine 122. In another embodiment, the signal may travel from the device 102 to the server 108 via the network 106 while bypassing the hub device 104. The signal may carry information about the event. Example information includes one or more of: a device ID of the device, a current state of the device (e.g., button pressed), a prior state of the device (e.g., button was previously unpressed, but now is pressed), a timestamp of the event, a location ID for a location in which the device is located, a user ID of a user of the device, among other information.

The rules engine 122 processes signals received corresponding to events based on the rules 114 stored in the database 112. The rules engine 122 may be configured to continuously monitor for certain events via polling or can be triggered to execute a rule based on a signal received corresponding to particular type of event. When processing a rule, the rules engine 122 may be configured to request information from one or more other devices besides the device that initiated the original signal. If one or more conditions for one or more rules are satisfied, the rules engine 122 can cause an action or series of actions to occur. These actions can be as simple as activating a relay on one hardware device or a complex series of actions involving two or more devices. The action can also involve sending a message or alert to one or more users or contacts.

In some embodiments, there is no limit to the length of the rule, the number of rules, the number of contacts or groups of contacts that can be notified, or the number of devices or third party hardware or software that can be connected. Each rule, group, contact, or variable can be modified on demand by the consumer via the management computing device 110.

In various embodiments, each rule can be configured to perform an action or a series of actions sequentially, in parallel, on a delay, or on a scheduled basis. Each rule can include an unlimited number of conditional requirements via AND/OR statements. Conditions include but are not limited to connected device states, third party device states, third party application states, variable settings, events generated by the disclosed devices 102, and/or events generated by the disclosed software or third party software. Actions can also include conditional IF statements, Else IF statements, Else statements, Switch Statements, While Statements, Loops and actions.

Actions include but are not limited to device calls to the disclosed devices 102, software calls to connected third party software, notification events via phone call, email, SMS or SNS messaging, remote code execution, web button activation, site updates, users' updates, contact updates, and rule updates. Actions can be configured with a delay between each action or each action condition that is evaluated.

In one example implementation, the event that triggers the rules engine 122 to be executed is a phone call received from a device 102 (e.g., mobile phone) to a dedicated phone number. Also, the action that occurs following execution of the rules engine 122 may be phone call placed to a device 102 (e.g., mobile phone).

For example, an inbound caller can hear the last notification message that was sent out from the server 108. Also, an authenticated user verified by caller ID can call a dedicated phone number and, instead of hearing the message, enter a PIN number to access a remote phone interface. From this remote phone interface, the caller can send a message outbound to another user or groups of users. The message may be pre-recorded or recorded at the time of call in. From the remote phone interface, the caller can trigger rules, web buttons, relays, third party devices or application events, or receive current variable information of connected devices.

Through the combination of a software and hardware components, the disclosed system 100 provides the consumer command and control over events that occur at one or more devices 102. Through the disclosed distributed architecture involving devices 102 and rules engine 122, the system 100 can integrate devices and software into an event-driven rule to provide cohesive solution to consumers.

The disclosed system 100 can process events from a wide variety of devices 102 and actions. The disclosed system 100 can also process rules that convert a detected event into actions and alerts managed by the consumer. Specifically, events sent from web-connected and/or IoT-based devices can be converted to singular or multiple actions that the customer can configure on a web portal via the management computing device 110. Providing this level of customer control allows nearly unlimited possibilities for leveraging would-be “single purpose devices” into a sophisticated set of actions and alerts across the customers enterprise to provide for unlimited uses or said devices.

In one embodiment, the management computing device 110 is a separate computing device from the server 108. In another embodiment, the management computing device 110 is the same computing device as the server 108. In one embodiment, the database 112 is separate from the server 108. In another embodiment, the database 112 is part of the server 108.

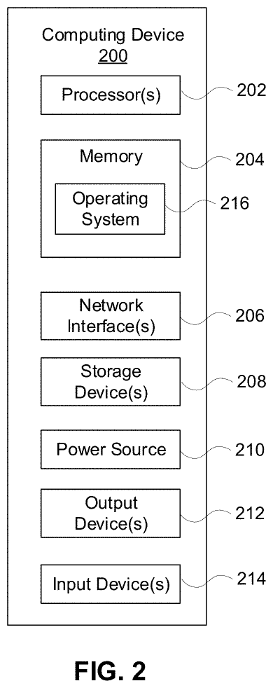

FIG. 2 is a block diagram of basic functional components for a computing device 200 according to some aspects of the disclosure. In the illustrated embodiment of FIG. 2, the computing device 200 includes one or more processors 202, memory 204, network interfaces 206, storage devices 208, power source 210, one or more output devices 212, one or more input devices 214, and software modules—e.g., an operating system 216—stored in memory 204. The software modules are provided as being included in memory 204, but in certain embodiments, the software modules are included in storage devices 208 or a combination of memory 204 and storage devices 208. Each of the components including the processor 202, memory 204, network interfaces 206, storage devices 208, power source 210, output devices 212, input devices 214, and operating system 216 are interconnected physically, communicatively, and/or operatively for inter-component communications.

In various embodiments, one or more of the device 102, hub device 104, management computing device 110, and server 108 shown in FIG. 1 may be implemented as a computing device 200 as shown in FIG. 2.

As illustrated, processor 202 is configured to implement functionality and/or process instructions for execution within computing device 200. For example, processor 202 executes instructions stored in memory 204 or instructions stored on a storage device 208. Memory 204, which may be a non-transient, computer-readable storage medium, is configured to store information within computing device 200 during operation. In some embodiments, memory 204 includes a temporary memory, an area for information not to be maintained when the computing device 200 is turned off. Examples of such temporary memory include volatile memories such as random access memories (RAM), dynamic random access memories (DRAM), and static random access memories (SRAM). Memory 204 also maintains program instructions for execution by the processor 202.

Storage device 208 also includes one or more non-transient computer-readable storage media. The storage device 208 is generally configured to store larger amounts of information than memory 204. The storage device 208 may further be configured for long-term storage of information. In some embodiments, the storage device 208 includes non-volatile storage elements. Non-limiting examples of non-volatile storage elements include magnetic hard discs, optical discs, floppy discs, flash memories, or forms of electrically programmable memories (EPROM) or electrically erasable and programmable (EEPROM) memories.

Computing device 200 uses network interface 206 to communicate with external devices, databases, or servers via one or more networks 106 (see FIG. 1), and other types of networks through which a communication with the computing device 200 may be established. Network interface 206 may be a network interface card, such as an Ethernet card, an optical transceiver, a radio frequency transceiver, or any other type of device that can send and receive information. Other non-limiting examples of network interfaces include Bluetooth®, 3G and Wi-Fi radios in client computing devices, ZigBee, Z-Wave, and Universal Serial Bus (USB), among others.

Computing device 200 includes one or more power sources 210 to provide power to the device. Non-limiting examples of power source 210 include single-use power sources, rechargeable power sources, and/or power sources developed from nickel-cadmium, lithium-ion, or other suitable material.

One or more output devices 212 are also included in computing device 200. Output devices 212 are configured to provide output to a user using tactile, audio, and/or video stimuli. Output device 212 may include a display screen (part of the presence-sensitive screen), a sound card, a video graphics adapter card, or any other type of device for converting a signal into an appropriate form understandable to humans or machines. Additional examples of output device 212 include a speaker such as headphones, a cathode ray tube (CRT) monitor, a liquid crystal display (LCD), or any other type of device that can generate intelligible output to a user.

The computing device 200 includes one or more input devices 214. Input devices 214 are configured to receive input from a user or a surrounding environment of the user through tactile, audio, and/or video feedback. Non-limiting examples of input device 214 include a photo and video camera, presence-sensitive screen, a mouse, a keyboard, a voice responsive system, microphone or any other type of input device. In some examples, a presence-sensitive screen includes a touch-sensitive screen.

The computing device 200 includes an operating system 216. The operating system 216 controls operations of the components of the computing device 200. For example, the operating system 216 facilitates the interaction of the processor(s) 202, memory 204, network interface 206, storage device(s) 208, input device 214, output device 212, and power source 210.

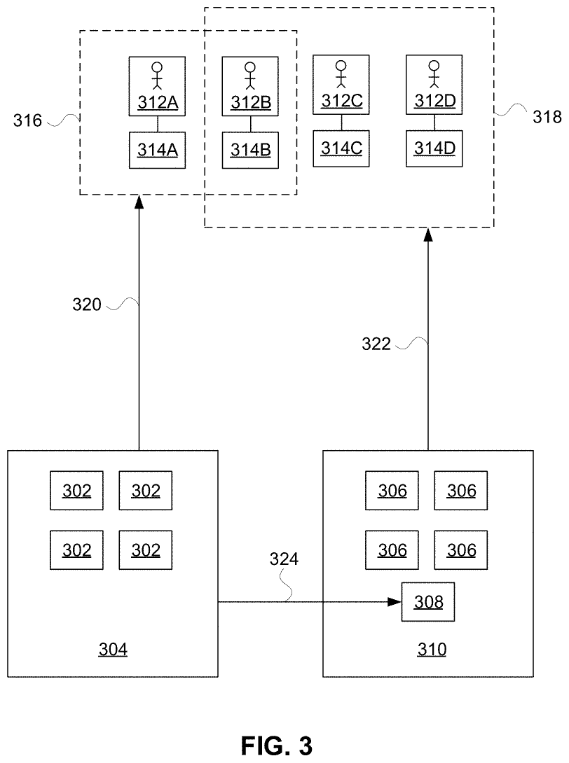

FIG. 3 is a block diagram illustrating an example use case of the disclosed system, according to one embodiment. Devices 302 are associated with and present at location 304. Devices 306, 308 are associated with and present at location 310. In one example, devices 302, 306, 308 can be mechanical switches or buttons. The locations 304, 310 may be, for example, different schools of a school district.

Users 312A-312D are associated with devices 314A-314D, respectively. The devices 314A-314D may be, for example, mobile phones. Users 312A and 312B are organized in user group 316. Users 312B, 312C, and 312D are organized in user group 318. In the example shown, user 312B is associated with both user group 316 and user group 318.

As described, a management computing device can be used to program one or more rules for one or more actions to occur in response to detecting one or more events. In one implementation, the rules are configured such that if one of the devices 302 at location 304 is triggered, then a notification is sent to the users in user group 316 (i.e., users 312A and 312B). The notification 320 may be received on the devices 314A, 314B corresponding to the users in user group 316.

The rules may be further configured such that if one of the devices 306 at location 310 is triggered, then a notification 322 is sent to the users in user group 318 (i.e., users 312B, 312C, and 312D). The notification may be received on the devices 314B, 314C, and 314D corresponding to the users in user group 318.

The rules may be further configured such that if one of the devices 302 at location 304 is triggered, then an action 324 may be configured to occur on device 308 at location 310. The action may be, for example, to set a timer. If the timer expires before another action 324 disables the timer, then the notification 322 may be sent to the users in user group 318, as an example.

In the example shown, each location (e.g., 304, 310) can include an unlimited number of devices. The devices can be activated to cause an event to be detected by the rules engine executed on a server communicatively coupled with the devices and/or a hub device at each location 304, 310. Executing the rules engine can cause one or more actions to occur, including sending notifications, activating a further rule, activating a different device at the same or a different location, sending information to a third party application, activating a request for information from a third party device, or pulling current variable information form a sensor or group of sensors, as a few examples.

In another example the rules can be programmed to:
Detect the value of a variable at a specific device (e.g., temperature reading on a thermostat device).
If the value of the variable is less than a threshold amount, then activate Relay 1 on Device 1, activate Relay 2 on Device 2, send a notification to User Group A via a phone call, and wait 5 minutes.
   After waiting 5 minutes:
      If Relay 1 on Device 1 is still active, send a notification to User Group 2;
      If Relay 2 on Device 2 is still active, activate Relay 3 on Device 3;
      After Relay 3 on Device 3 is activated, a warning light is powered ON; and
      Wait 5 more minutes.
   After waiting 5 more minutes:
      If Relay 1 on Device 1 is still active, send a notification to User Group A, User Group B, and User Group C;
      Turn off Relay 3 on Device 3;
      Activate Relay 4 on Device 3;
      After Relay 4 on Device 3 is activated, an alarm light is powered ON; and
      Wait 5 more minutes.
   After waiting 5 more minutes:
      If Relay 1 on Device 1 is deactivated, send an “all clear” message to User Group A, User Group B, and User Group C.
If the value of the variable is NOT less than the threshold amount, then send a notification to User Group D.

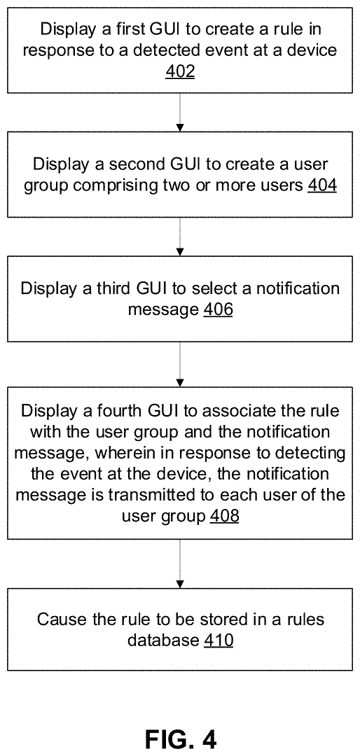

FIG. 4 is a flow diagram of method steps for generating a rule to cause one or more actions in response to detecting one or more events, according to one embodiment.

At step 402, a computing device (e.g., management computing device 110 in FIG. 1) displays a first GUI (graphical user interface) to create a rule in response to a detected event at a device. At step 404, the computing device displays a second GUI to create a user group comprising two or more users. At step 406, the computing device displays a third GUI to select (and/or create) a notification message. At step 408, the computing device displays a fourth GUI to associate the rule with the user group and the notification message, wherein in response to detecting the event at the device, the notification message is transmitted to each user of the user group. At step 410, the computing device causes the rule to be stored in a rules database.

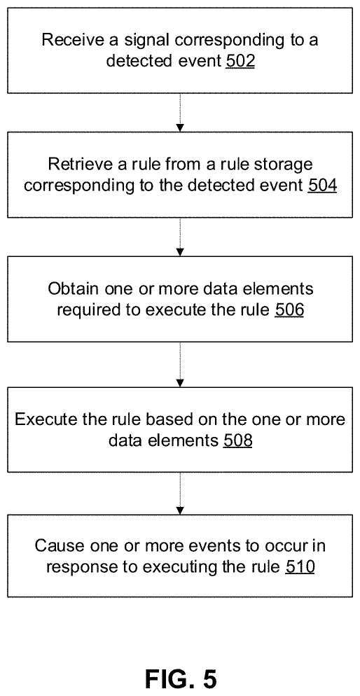

FIG. 5 is a flow diagram of method steps for executing a rule to cause one or more actions in response to detecting one or more events, according to one embodiment.

At step 502, a computing device (e.g., server 108 executing a rules engine 122 in FIG. 1) receives a signal corresponding to a detected event. At step 504, the computing device retrieves a rule from a rule storage corresponding to the detected event. At step 506, the computing device obtains one or more data elements required to execute the rule. The one or more data elements may be from one or more different devices than the device at which the event was detected. At step 508, the computing device executes the rule based on the one or more data elements. At step 510, the computing device causes one or more events to occur in response to executing the rule.

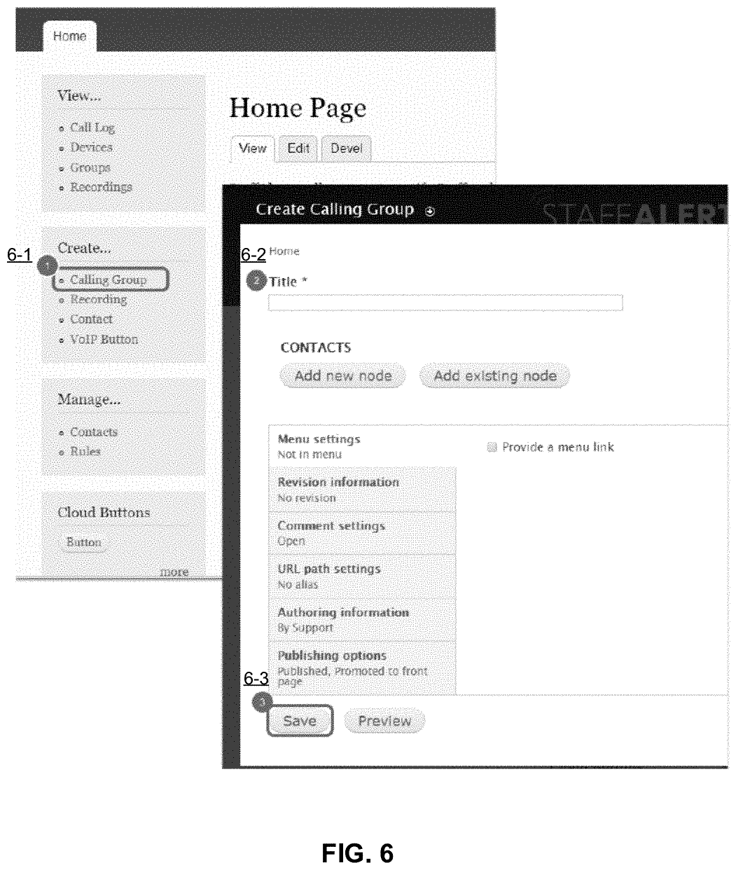

FIGS. 6-8 illustrate example GUIs (graphical user interfaces) for creating a new Calling Group, according to one embodiment.

In FIG. 6, GUIs are provided to create a new Calling Group by: from a “Create” area on the left hand side of the GUI, select Calling Group (6-1); enter a Title for the Calling Group (6-2); and, select Save to save the calling group (6-3).

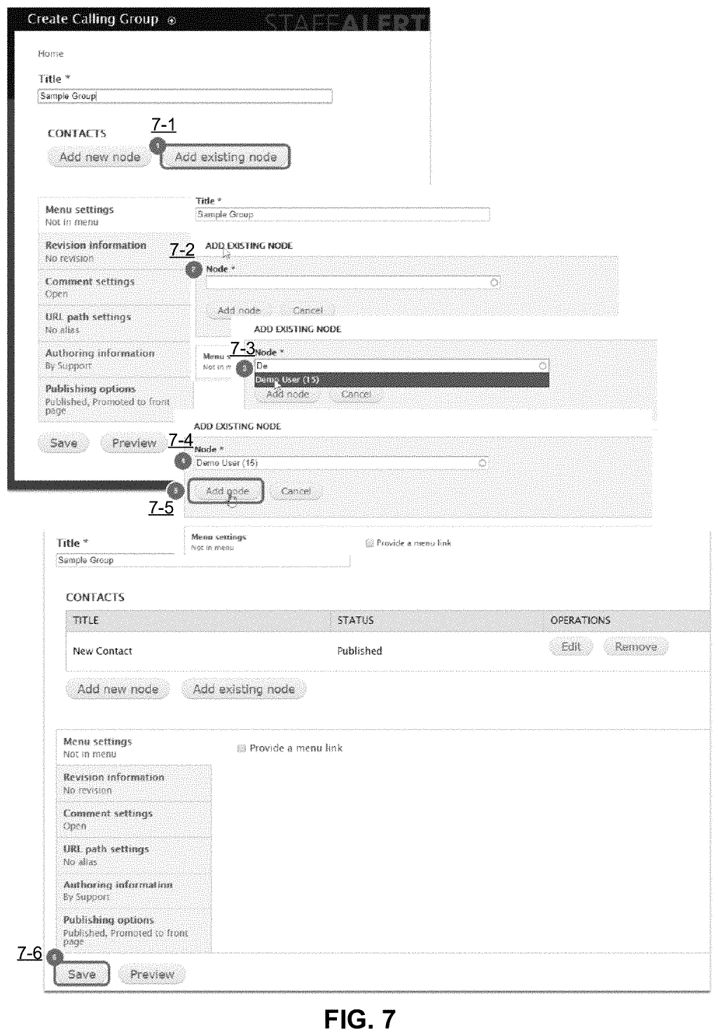

In FIG. 7, GUIs are provided to add an existing contact to the Calling Group by: prior to saving the new Calling Group, click “Add existing node” to add a contact (7-1); click in the box (7-2); start typing the desired user name (7-3); select the name from drop down when shown (7-4); click AddNode (7-5); and, click Save (7-6).

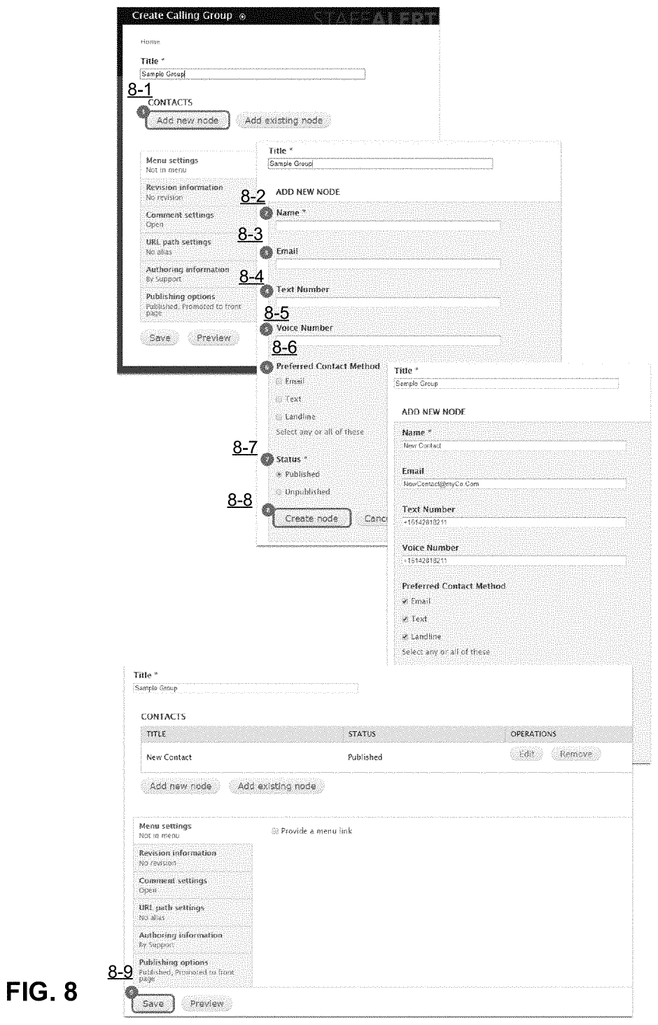

In FIG. 8, GUIs are provided to add an existing contact to the Calling Group by: prior to Saving the new Calling Group, click Add new Node to add a contact (8-1); enter the Contact Name (8-2); enter the Contact Email (8-3); enter the Contact SMS/Text Number (e.g., enter “+1” in front of the 10 digit number) (8-4); enter the Contact Voice Phone Number (8-5); select the Preferred Contact Method for this Contact (8-6); verify Status is set to Published (8-7); click Create Node (8-8); and, once all Contacts have been created, Click Save to save the group and all the contacts (8-9). Once a new Contact has been added and assigned to the group, additional Contacts can be added to the group by repeating steps 8-1 to 8-8.

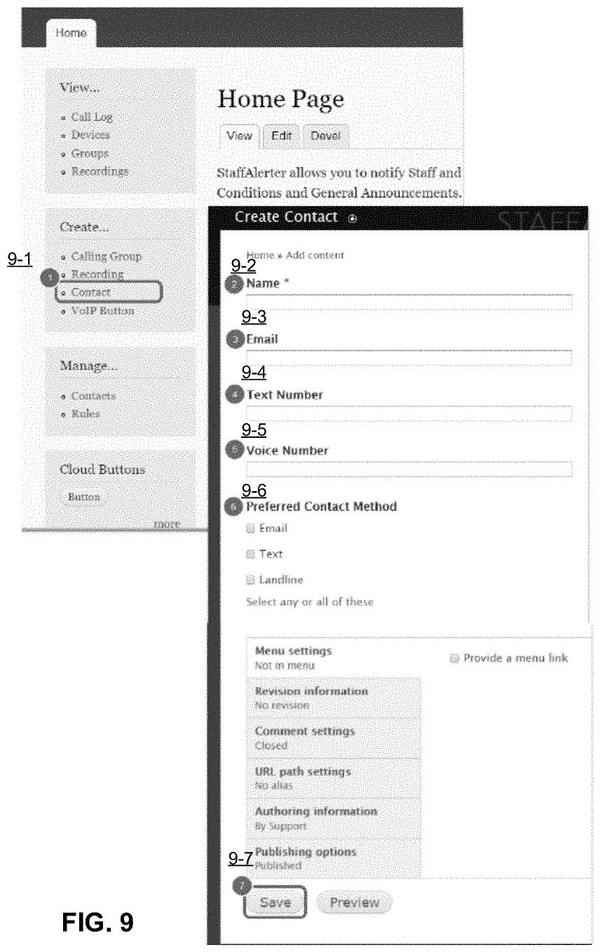

In FIG. 9, GUIs are provided to create a new contact by: from the “Create” area on the left hand side of the page, select Contact (9-1); enter the Contact Name (9-2); enter the Contact Email (9-3); enter the Contact SMS/Text Number (e.g., enter “+1” in front of the 10 digit number) (9-4); enter the Contact Voice Phone Number (9-5); select the Preferred Contact Method for this Contact (9-6); and, click Save (9-7).

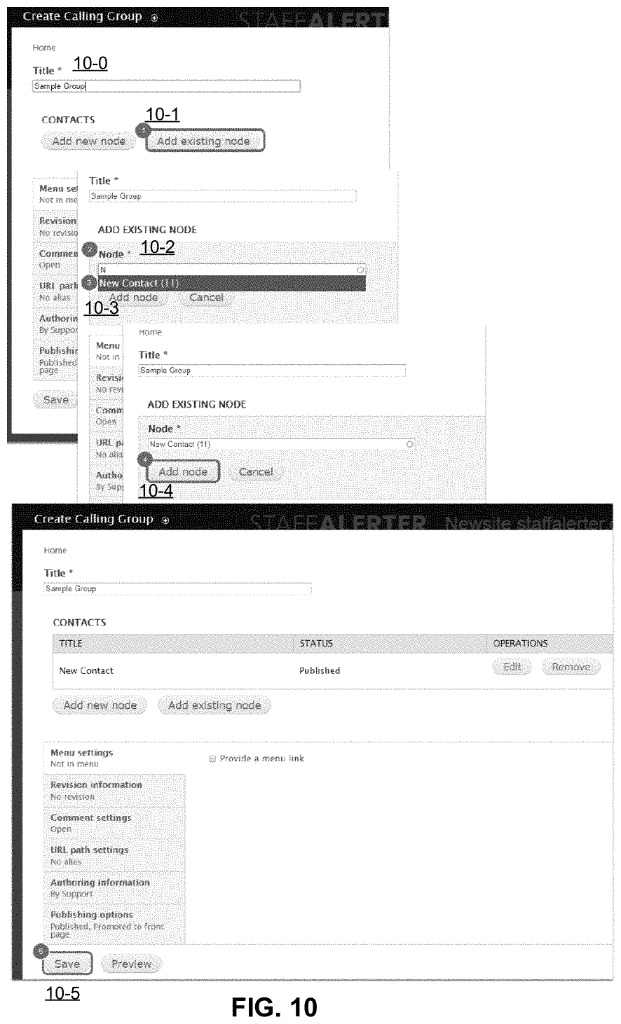

In FIG. 10, GUIs are provided to add an existing contact to a new calling group by: enter a Title for the Calling Group (10-0); prior to saving the new Calling Group, click Add existing node to add a contact (10-1); in the Node box start typing the name of the existing contact, the box will show any results that match (10-2); select the correct Contact from the results in the drop down box (10-3); click Add Node, the contact will be added to the group (10-4); and, once all Contacts have been created, click Save to save the group and all the contacts (10-5).

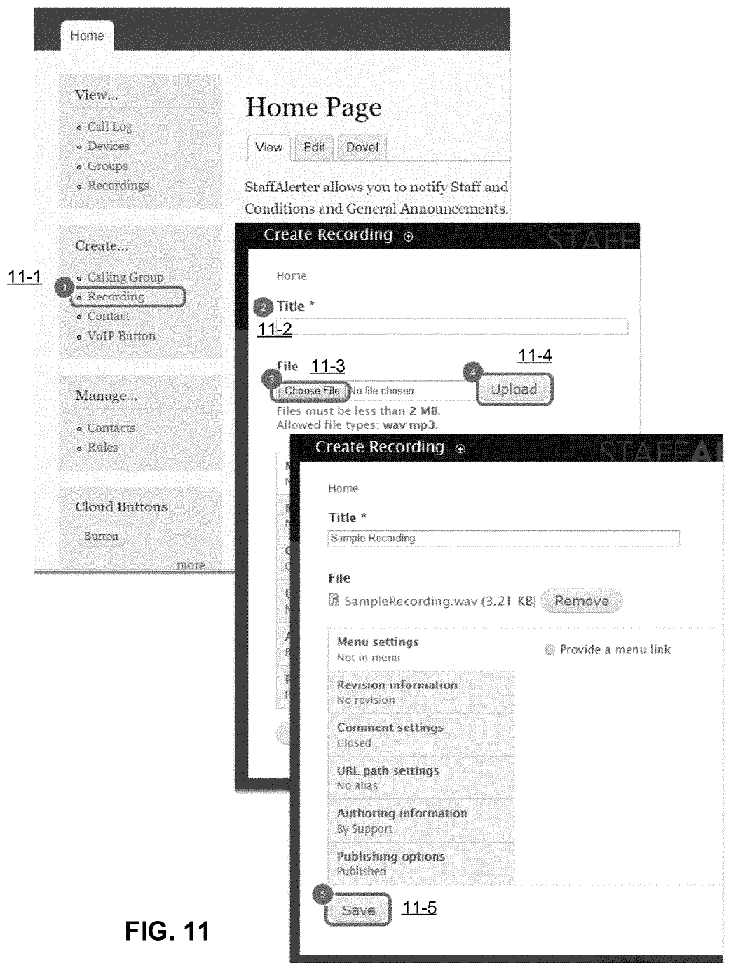

In FIG. 11, GUIs are provided to create a new recording to be used for notifications by: from the “Create” area on the left hand side of the page, select Recording (11-1); enter the Title for the recording (11-2); click Choose File, to select a file from the computer to upload (11-3); click Upload to upload the file to the web site (11-4); and, click Save (11-5).

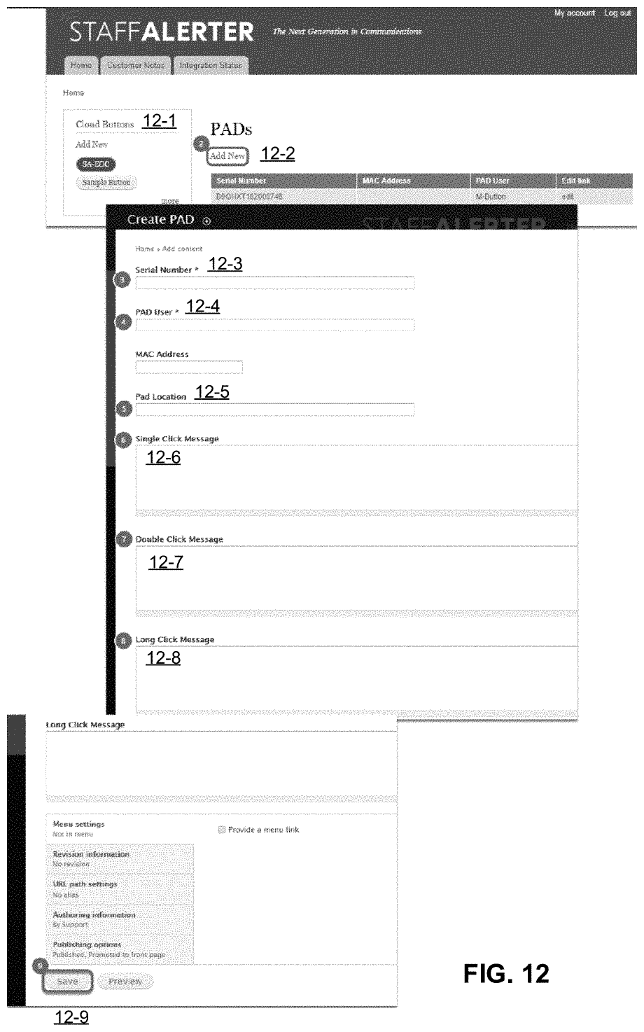

In FIG. 12, GUIs are provided to add a new PAD (personal alert device) to the system by: from a Management area (12-1), click Add New (12-2), which causes a new window to appear; fill out the Serial number with the DSN (device serial number) on the back of the PAD or on the front of the box (12-3); fill out the PAD User with the user that will be primarily using the PAD device (12-4); fill out the PAD Location with the location the PAD device will be assigned to (the PAD units do not have GPS or other location technology built in, however you can use rogue detection if it is a feature of the WiFi network at the customers site) (12-5); fill out the Single Click Message if desired (this allows a message custom to the PAD device to be sent, Replacement Patterns cannot be used here) (12-6); fill out the Double Click Message if desired (this allows a message custom to the PAD device to be sent, Replacement Patterns cannot be used here) (12-7); fill out the Long Click Message if desired (this allows a message custom to the PAD device to be sent, Replacement Patterns cannot be used here) (12-8); and, click Save to save the PAD settings (12-9).

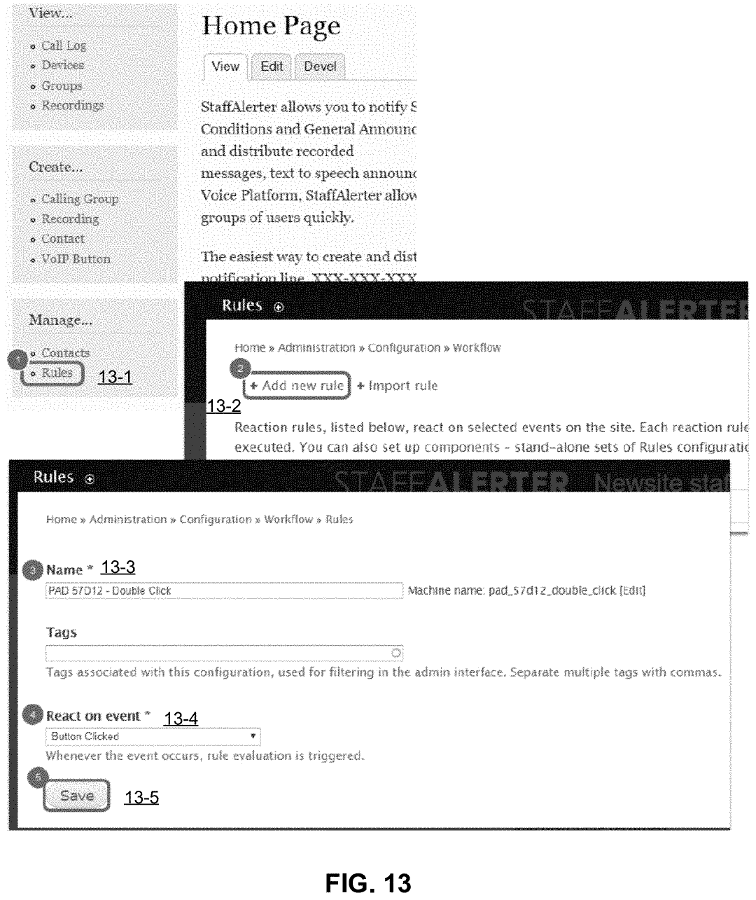

In FIG. 13, GUIs are provided to add a new rule to the system by: from the “Manage” area on the left hand side of the page, select Rules (13-1); select+Add new rule (13-2); enter in the Name of the Rule (e.g., use the last 5 numbers/letters of the PAD DSN to identify the rule for the specific device, optionally add the Click pattern (Single, Double, Long) in the name) (13-3); select the event to react upon (13-4); and, click Save (13-5).

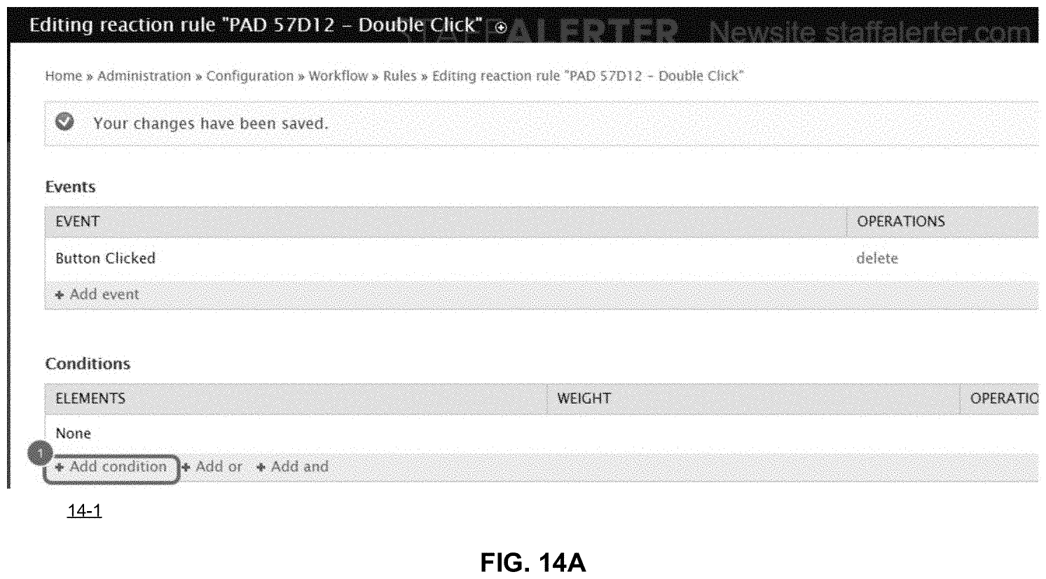

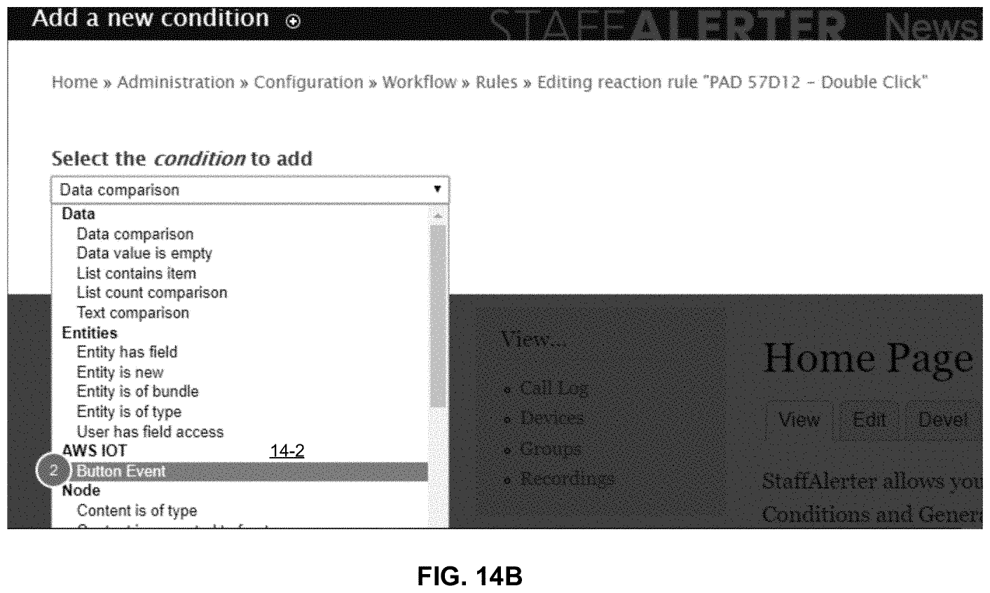

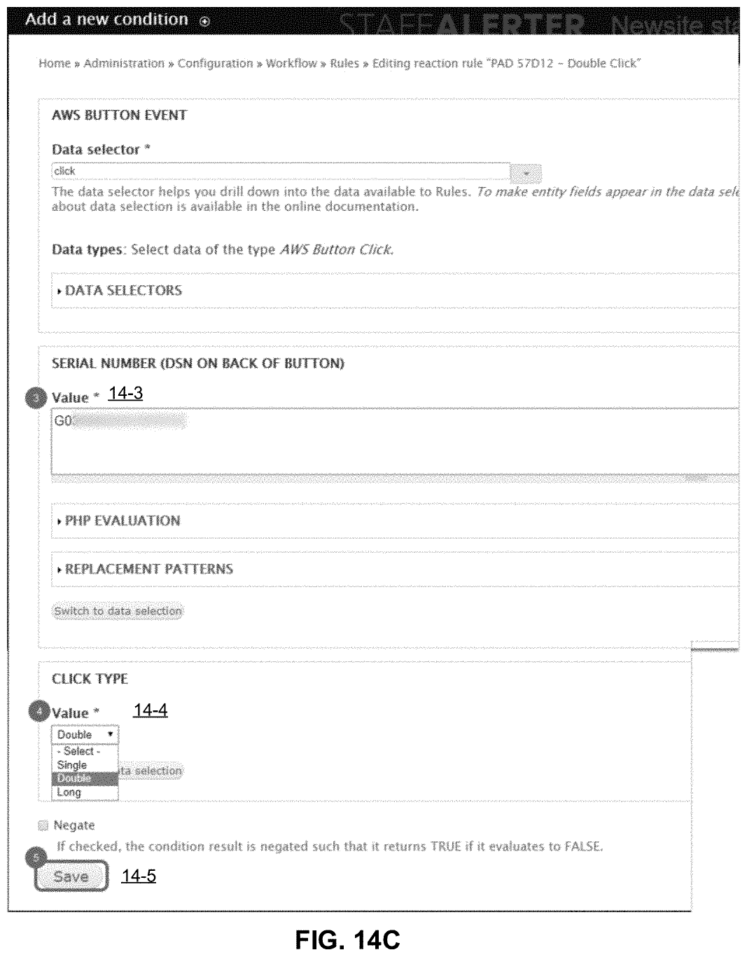

In FIGS. 14A-14C, GUIs are provided to add conditions to a rule by: under Conditions, click+Add Condition (14-1); click the drop down and select AWS IOT>Button Event (14-2); a new window will appear, Under Serial Number>Value enter the DSN from the back of the PAD Button (14-3); under Click Type>Value, Select the desired value (Single, Double, Long) (14-4); and, click Save (14-5).

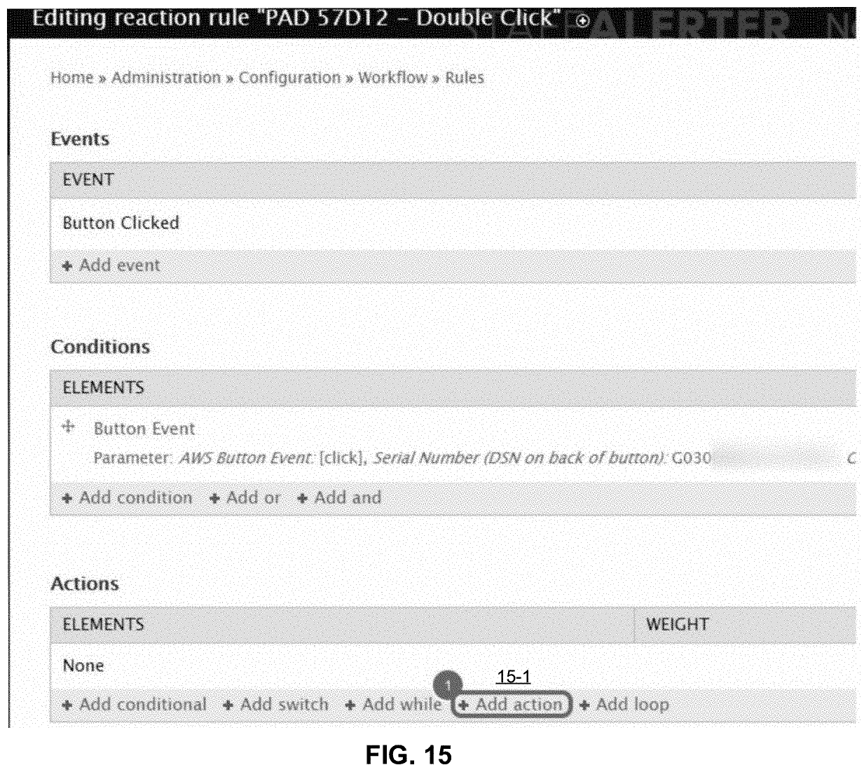

In FIG. 15, a GUI is provided to add actions to a rule by selecting “+Add action” (15-1).

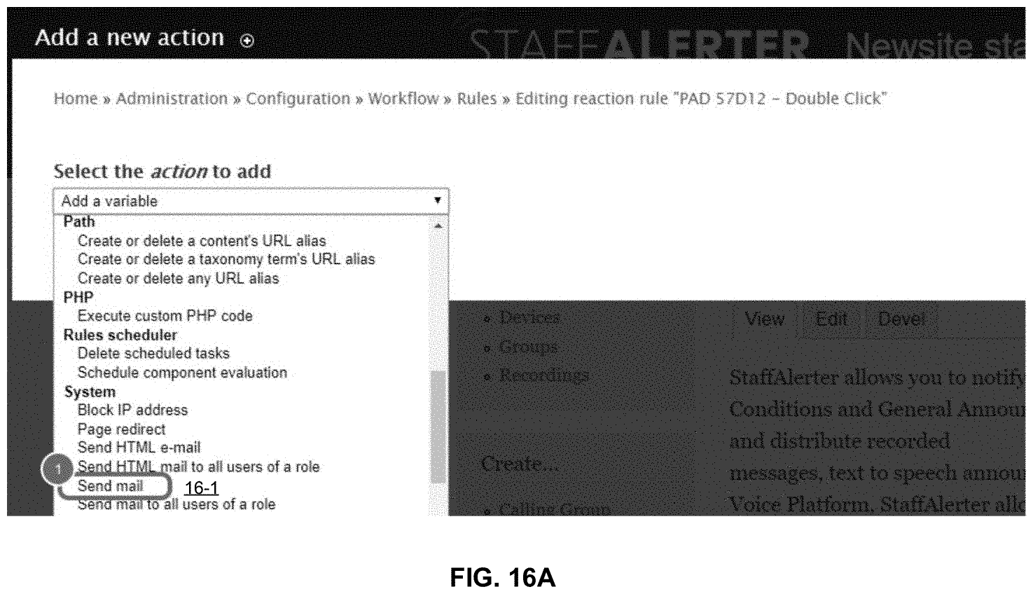

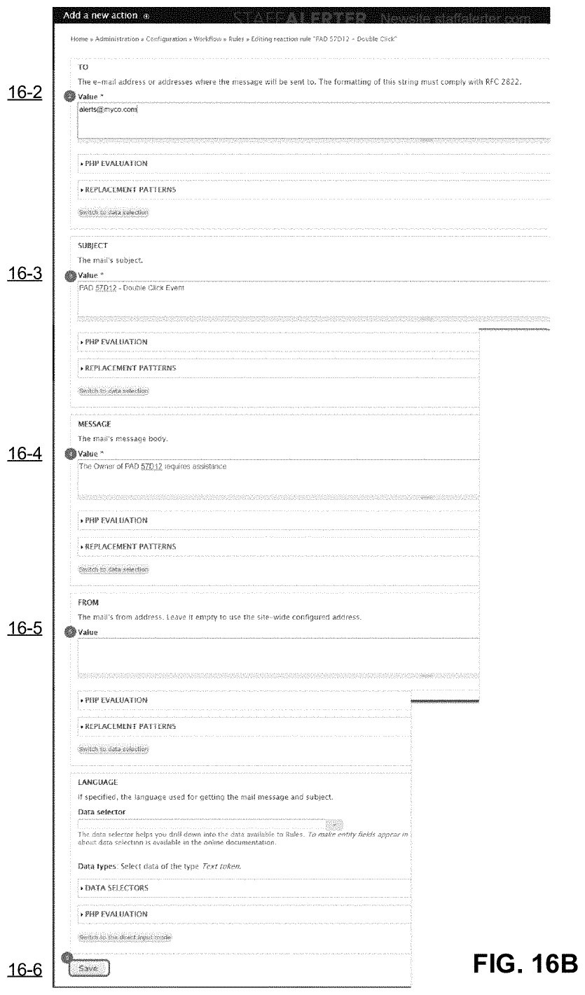

In FIGS. 16A-16B, GUIs are provided to add an action to send an email to one or more individuals by: from a drop down Select System>Send Mail (16-1); enter in the To Value for who will receive the email alert (e.g., multiple emails can be separated with a comma followed by a space, such as “user1@myco.com, user2@myco.com”) (16-2); enter the Subject Value for the email (16-3); enter the Message Value for the email (16-4); leave the From Value blank (16-5); click Save (16-6). The server may be configured with an email client to send the emails.

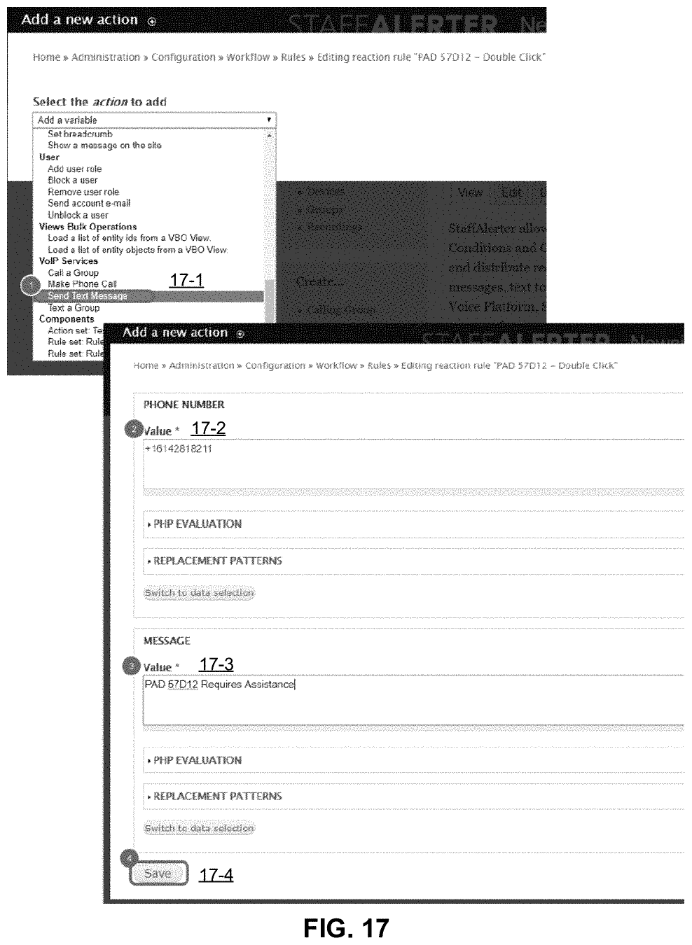

In FIG. 17, GUIs are provided to add an action to send a text message to an individual by: from the drop down select VoIP Services>Send Text Message (17-1); enter in the Phone Number Value for who will receive the SMS Text Alert (17-2); enter the Message Value for the email (17-3); click Save (17-4). The server may be configured with a text client to send the emails. The texts can be cellular or IP-based texts.

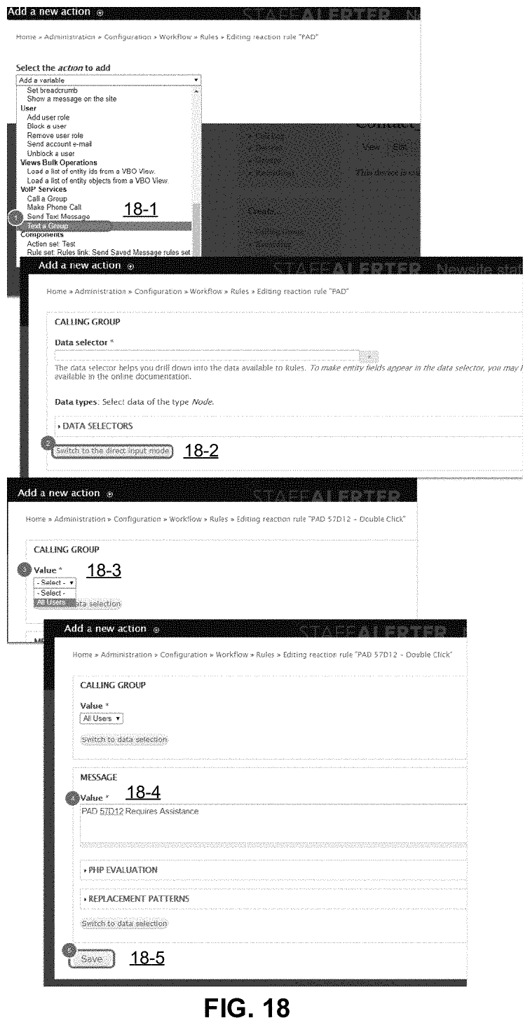

In FIG. 18, GUIs are provided to add an action to send a text message to a group by: from the drop down select VoIP Services>Text a Group (18-1); click Switch to the direct input mode (18-2); from the Calling Group>Value drop down select the Group desired (18-3); enter the Message Value for the email (18-4); click Save (18-5).

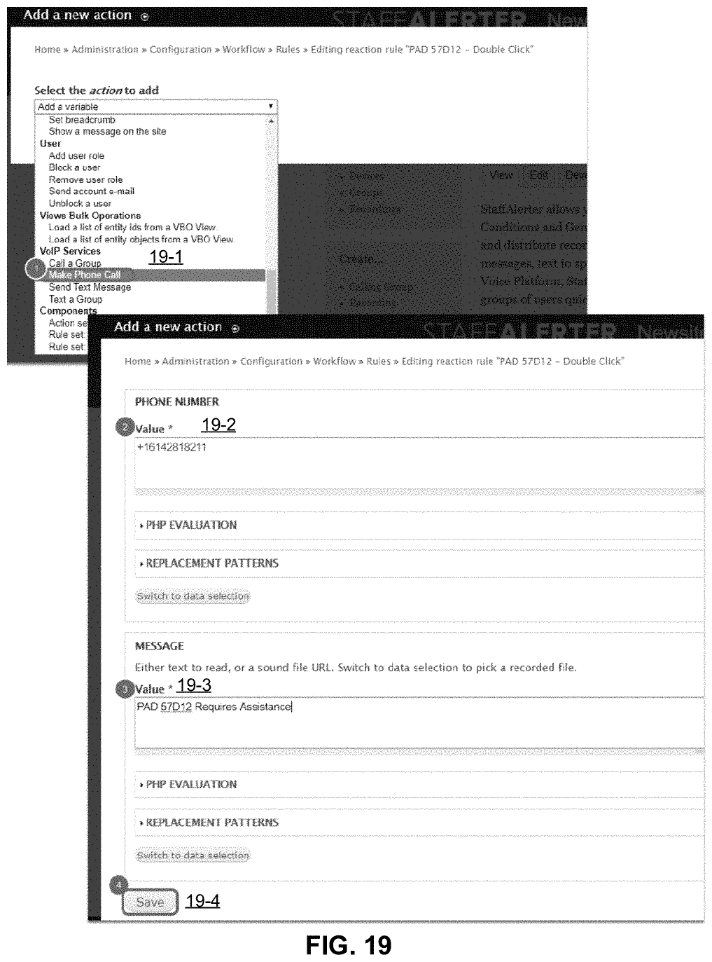

In FIG. 19, GUIs are provided to add an action to make a phone call to an individual where the text is read to the called party by: from the drop down select VoIP Services>Make Phone Call (19-1); enter in the Phone Number Value for who will receive the Phone Call Alert (19-2); enter the Message Value for the phone call (this is what will be read in an automated voice to the called party) (19-3); click Save (19-4).

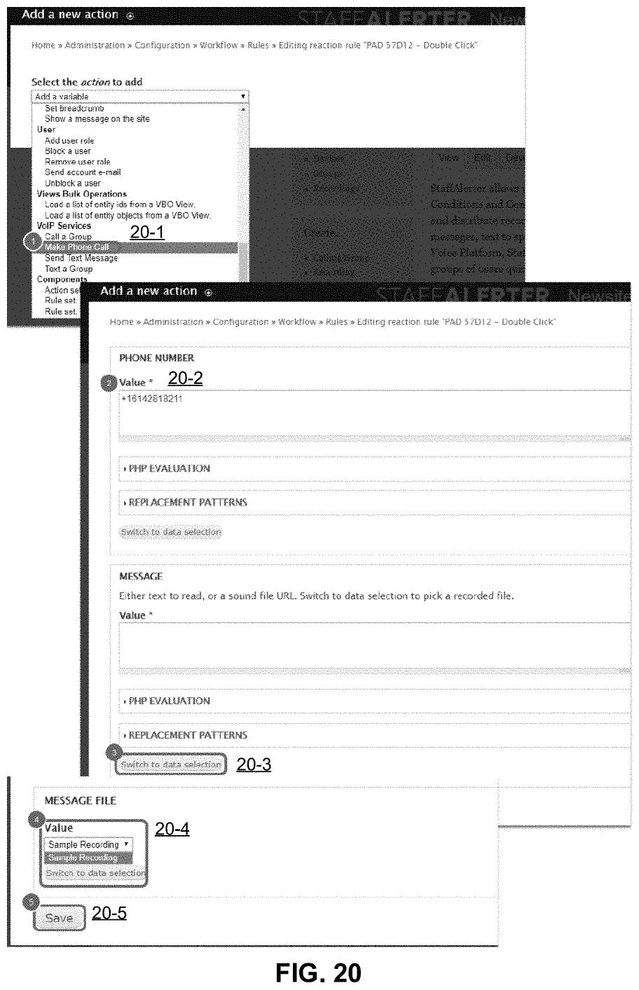

In FIG. 20, GUIs are provided to add an action to make a phone call to an individual where a recording is played to the called party by: from the drop down select VoIP Services>Make Phone Call (20-1); enter in the Phone Number Value for who will receive the Phone Call Alert (20-2); under Message Click Switch to Data Selection (20-3); from the drop down Select Recording Name (20-4); click Save (20-5).

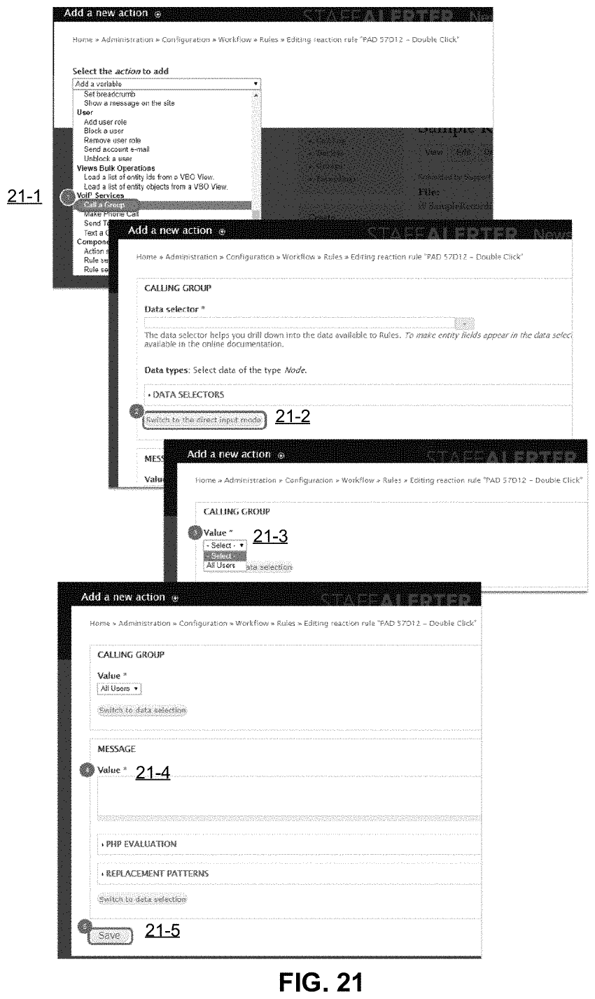

In FIG. 21, GUIs are provided to add an action to make a phone call to a group where the text is read to the called party/parties by: from the drop down select VoIP Services>Make Phone Call (21-1); click Switch to the direct input mode (21-2); from the Calling Group>Value drop down select the Group desired (21-3); enter the Message Value for the phone call (this is what will be read in an automated voice to the called party (21-4); click Save (21-5).

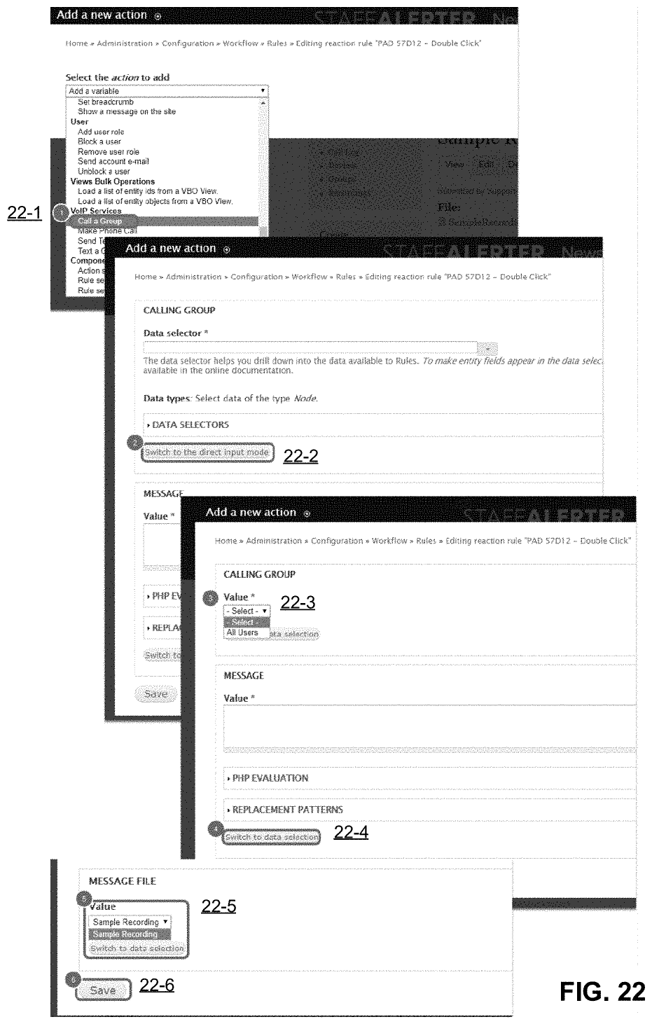

In FIG. 22, GUIs are provided to add an action to make a phone call to a group where a recording is played to the called party/parties by: from the drop down select VoIP Services>Make Phone Call (22-1); click Switch to the direct input mode (22-2); from the Calling Group>Value drop down select the group desired (22-3); under Message Click Switch to Data Selection (22-4); from the drop down SelectRecordingName (22-5); click Save (22-6).

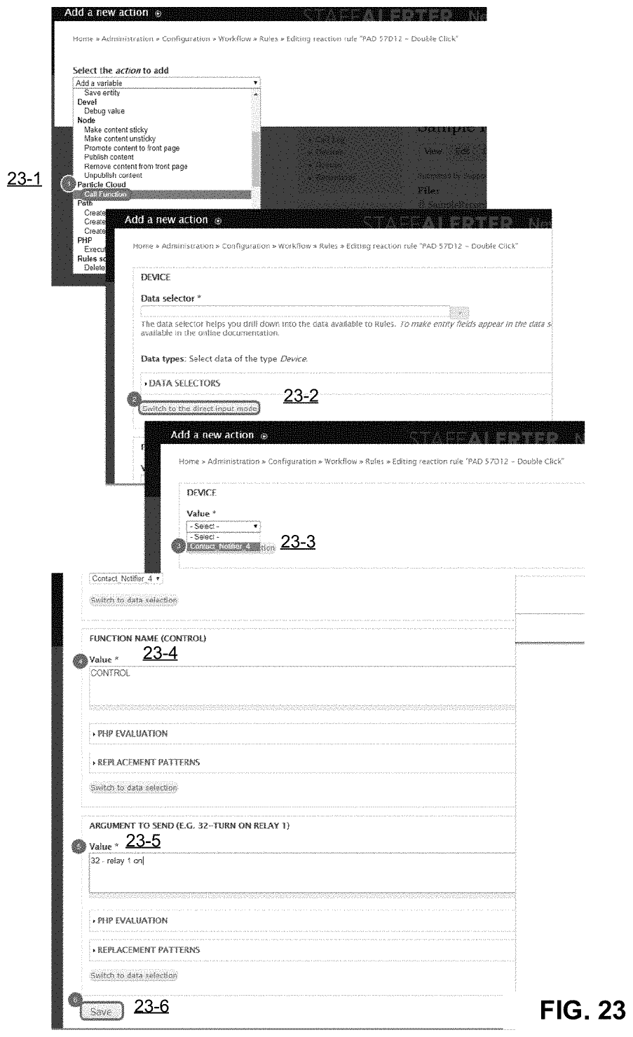

In FIG. 23, GUIs are provided to add an action to trigger a relay by: from the drop down select Particle Cloud>Call Function (23-1); click Switch to the direct input mode (23-2); from the Device>Value drop down select a contact for the site (23-3); set Function Name>Value to CONTROL (23-4); set Argument to Sent>Value to the appropriate device address and relay action (23-5); click Save (23-6).

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following embodiments) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “includeing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method in a computing device for operating an Internet of things (IoT) ecosystem composed of devices having disparate sources or functions and that are capable of input/output (I/O) of signals to or from a server associated with the IoT ecosystem, the method comprising:
providing a user interface to a user positioned remote from the server;
receiving, from the user via the user interface:
configuration data to configure a plurality of devices positioned remote from, and in communication with, the server; and
rule data including user-defined rules governing one or more processing actions for execution by the server upon receipt by the server of one or more input signals from a first device of the plurality of devices;
storing the configuration data and the rule data in a memory device in association with the server;
wherein in response to the server receiving the one or more input signals from the first device, the server determines one or more output signals according to the rule data and the configuration data; and
wherein the server causes the one or more output signals to be transmitted to at least one second device of the plurality of devices to cause an event to occur at the second device.

2. The method of claim 1,
wherein providing the user interface to the user comprises providing a graphical user interface (GUI) on a display device to receive modifications of the configuration data and the rules data by the user; and
wherein receiving the configuration data and the rules data from the user comprises receiving the configuration data and the rules data via the GUI.

3. The method of claim 2, wherein:
the GUI further includes a graphical button; and
the first device comprises a user device operated by the user; and
receiving the one or more input signals from the first device comprises receiving an input signal from the user device corresponding to the graphical button being activated by the user.

4. The method of claim 1, wherein:
the first device includes a personal alerting device (PAD);
receiving the one or more input signals from the first device comprises receiving the one or more input signals from a hub device positioned in communication with the PAD and the server;
wherein the hub device is located in a same location as the PAD device; and
wherein the hub device is located in a different location as the server.

5. The method of claim 1, wherein:
the at least one second device includes at least one user device associated with the user;
the rules data includes at least one predetermined message; and
transmitting the one or more output signals to the at least one second device comprises transmitting the at least one predetermined message to the at least one user device.

6. The method of claim 1, wherein:
the configuration data includes one or more of:
at least one telephone number associated with the user;
at least one email address associated with the user; or
at least one social media account associated with the user;
the rules data includes at least one predetermined message; and
transmitting the one or more output signals to the at least one second device comprises transmitting the at least one predetermined message to the one or more of: the at least one telephone number, the at least one email address, or the at least one social media account.

7. The method of claim 1, further comprising:
receiving one or more signals from the first device or the at least one second device, wherein the one or more signals are representative of an operational status of the first device or the at least one second device; and
determining the operational status of the first device or the at least one second device based on the one or more signals representative of the operational status of the first device or the at least one second device.

8. The method of claim 7, further comprising:
determining one or more control signals according to the operational status of the first device or the at least one second device; and
transmitting the one or more control signals to the first device or the at least one second device to maintain or change to the operational status of the first device or the at least one second device.

9. The method of claim 7, wherein:
the at least one second device further includes at least one user device associated with the user;
the rules data includes at least one device operational status message; and
transmitting the one or more control signals to the first device or the at least one second device comprises transmitting the at least one device operational status message to the at least one user device.

10. The method of claim 1, wherein:
the first device includes at least one of: a sensor, an actuator, or a communication device;
the at least one second device includes, or is operably coupled to, one or more components of a facility control system associated with the identity of the user; and
transmitting the one or more output signals to the at least one second device further facilitates control of physical infrastructure of the facility according to the one or more input signals received from the first device.

11. The method of claim 10, wherein:
the at least one second device further includes at least one user device associated with the identity of the user;
the rules data includes at least one facility control status message; and
transmitting the one or more output signals to the at least one second device comprises transmitting the at least one facility control status message to the at least one user device.

12. The method of claim 1, wherein the server causes the one or more output signals to be transmitted to at least two second devices of the plurality of devices to cause the event to occur at the at least two second devices.

13. A non-transitory computer-readable storage medium storing instructions that, when executed by a processor, cause a computing device to perform a method for operating an Internet of things (IoT) ecosystem composed of devices having disparate sources or functions and that are capable of input/output (I/O) of signals to or from a server associated with the IoT ecosystem, by performing the steps of:
providing a user interface to a user positioned remote from the server;
receiving, from the user via the user interface:
configuration data to configure a plurality of devices positioned remote from, and in communication with, the server; and
rule data including user-defined rules governing one or more processing actions for execution by the server upon receipt by the server of one or more input signals from a first device of the plurality of devices;
storing the configuration data and the rule data in a memory device in association with the server;
wherein in response to the server receiving the one or more input signals from the first device, the server determines one or more output signals according to the rule data and the configuration data; and
wherein the server causes the one or more output signals to be transmitted to at least one second device of the plurality of devices to cause an event to occur at the second device.

14. The computer-readable storage medium of claim 13,
wherein providing the user interface to the user comprises providing a graphical user interface (GUI) on a display device to receive modifications of the configuration data and the rules data by the user; and
wherein receiving the configuration data and the rules data from the user comprises receiving the configuration data and the rules data via the GUI.

15. The computer-readable storage medium of claim 14, wherein:
the GUI further includes a graphical button; and
the first device comprises a user device operated by the user; and
receiving the one or more input signals from the first device comprises receiving an input signal from the user device corresponding to the graphical button being activated by the user.

16. The computer-readable storage medium of claim 13, wherein:
the first device includes a personal alerting device (PAD);
receiving the one or more input signals from the first device comprises receiving the one or more input signals from a hub device positioned in communication with the PAD and the server;
wherein the hub device is located in a same location as the PAD device; and
wherein the hub device is located in a different location as the server.

17. The computer-readable storage medium of claim 13, wherein:
the at least one second device includes at least one user device associated with the user;
the rules data includes at least one predetermined message; and
transmitting the one or more output signals to the at least one second device comprises transmitting the at least one predetermined message to the at least one user device.

18. The computer-readable storage medium of claim 13, wherein:
the configuration data includes one or more of:
at least one telephone number associated with the user;
at least one email address associated with the user; or
at least one social media account associated with the user;
the rules data includes at least one predetermined message; and
transmitting the one or more output signals to the at least one second device comprises transmitting the at least one predetermined message to the one or more of: the at least one telephone number, the at least one email address, or the at least one social media account.

19. The computer-readable storage medium of claim 13, wherein the server causes the one or more output signals to be transmitted to at least two second devices of the plurality of devices to cause the event to occur at the at least two second devices.

20. A computing device, comprising:
a memory storing instructions; and
a processor configured to execute the instructions to cause the computing device to operate an Internet of things (IoT) ecosystem composed of devices having disparate sources or functions and that are capable of input/output (I/O) of signals to or from a server associated with the IoT ecosystem, by performing the steps of:
providing a user interface to a user positioned remote from the server;
receiving, from the user via the user interface:
configuration data to configure a plurality of devices positioned remote from, and in communication with, the server; and
rule data including user-defined rules governing one or more processing actions for execution by the server upon receipt by the server of one or more input signals from a first device of the plurality of devices;
storing the configuration data and the rule data in a memory device in association with the server;
wherein in response to the server receiving the one or more input signals from the first device, the server determines one or more output signals according to the rule data and the configuration data; and
wherein the server causes the one or more output signals to be transmitted to at least one second device of the plurality of devices to cause an event to occur at the second device.
